(19) United States
(12) Patent Application Publication
(10) Pub. No.: US 2006/0113509 A1
(43) Pub. Date: Jun. 1, 2006

(54) Hydrophobic-hydrophilic compounds for treating metallic surfaces

(75) Inventors: Ralf Norenberg, Ingelheim (DE); Christian Wulff, Mannheim (DE); Monica Fernandez Gonzalez, Heideberg (ES); Helmut Witteler, Wachenheim (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 10/540,466

(22) PCT Filed: Dec. 19, 2003
(86) PCT No.: PCT/EP03/14582

§ 371 Date: Jun. 23, 2005

(30) Foreign Application Priority Data
Dec. 23, 2002 (DE) 102 610559.4
Apr. 25, 2003 (DE) 103 18 981.5

(51) Int. Cl. B05D 3/12; C09K 3/00; C23F 11/00

(52) U.S. Cl. 252/389.1; 427/358; 252/389.2

(57) ABSTRACT

Compounds of the formula X-Y-L-(W-Z)ₙ, in which a hydrophobic moiety and a hydrophilic moiety are linked to one another, and where X is an endgroup which is able to develop strong chemical and/or physical interactions toward metal surfaces, Y is an aliphatic hydrocarbon group, L is a linking group, W is a hydrophilic group, and Z is a further endgroup; formulations comprising these compounds; and also to the use of the compounds to treat metal surfaces.

The present invention relates to compounds of the formula X-Y-L-(W-Z)ₙ, in which a hydrophobic moiety and a hydrophilic moiety are linked to one another, and where X is an endgroup which is able to develop strong chemical and/or physical interactions toward metal surfaces, Y is an aliphatic hydrocarbon group, L is a linking group, W is a hydrophilic group, and Z is a further endgroup. The invention further relates to formulations comprising these compounds and also to the use of the compounds to treat metal surfaces.

The treatment of metallic surfaces with suitable means for any of a very wide variety of end applications possesses great economic importance. Typical applications include treatments to prevent corrosion, to render surfaces hydrophilic or hydrophobic, or to improve adhesion with further layers, such as paint coats, for example.

Corrosion is retarded or prevented using protective films and/or corrosion inhibitors. Whereas a protective film is applied permanently to the metal, a corrosion inhibitor is normally added to substances, such as liquid mixtures, for example, which on contact with the metal would initiate or accelerate corrosion. Systems possessing high suitability from a technical standpoint are required not only to have the corrosion-inhibiting action but also to satisfy a number of additional requirements. For example, they should be able to be applied evenly to a metal surface and should have a good barrier effect with respect to corrosion-stimulating gases and liquids. Furthermore, the components of the protective films and/or corrosion inhibitors ought to be readily available in sufficient quantity and ought also to be very inexpensive.

Compounds having a corrosion-inhibiting action must also meet a range of still-further requirements. Protective films applied to prevent corrosion often form only one layer in an assembly of layers. A simple example is a metallic surface, which for the purpose of corrosion protection is first coated with a composition suitable for that purpose, and then atop that layer a further coating, such as a paint, for example, is applied. Compounds used for this purpose must on the one hand have a good corrosion protection effect. On the other hand they must also exhibit very good adhesion in respect both of the metallic surface and of the additional coat, in order to give the assembly sufficient strength.

Modern automobile bodies or else materials for household appliances, with a high level of resistance to rusting through, are normally produced in multistage operations and have many different layers. They are typically composed of a steel sheet, which is first of all galvanized electrochemically or by a hot-dip method. The galvanized metal sheet is normally phosphated, in order to improve the corrosion protection and the adhesion of further layers. This is normally followed by aftertreatment with Cr(VI) solutions or other solutions. Finally, a primer layer of organic materials is applied. The metal sheet treated in this way is subsequently coated with one or—more usually—two or more different paint coats. It would be very desirable to replace this complicated layer structure by a simpler layer structure with fewer layers but with at least equal or, preferably, better corrosion protection. It would be especially desirable to be able to avoid the phosphating and the aftertreatment and instead, to use a single primer layer which takes over functions of these layers.

WO 98/29580 proposed treating metallic surfaces using aqueous solutions of compounds of type XYZ, with Y being straight-chain hydrophobic groups, X acidic groups such as carboxylate or phosphate, and Z various acidic, basic and/or reactive groups. X serves for attachment to the metallic surface and Z for attachment to the coating system. The overcoatability of metallic surfaces coated with these compounds, however, particularly when using aqueous basecoats, is not always good. Moreover, for optimum attachment to the coating system, the group Z ought to be able to be individually matched to the particular coating system. Some combinations of X and Z, however, involve extremely difficult chemical syntheses.

EP-A 441 765 and JP-A 06-136014 disclose linear compounds in which a hydrophobic moiety and a hydrophilic moiety are linked directly to one another. They have a COOH group at the hydrophobic end and a R—O— group at the hydrophilic end. Applications of these compounds in corrosion protection, and other endgroups, are not disclosed.

WO 99/52574 discloses biopolymer-repellent coatings intended for coating reaction vessels, for example. Coating is carried out using compounds in which a hydrophobic moiety, a hydrocarbon radical for example and a hydrophilic moiety, a polyoxyalkylene radical for example, are linked directly to one another. The hydrophobic radical has an endgroup such as —COOH, —PO(OH)₂ or —SiCl₃, for example, while the endgroup on the hydrophilic radical is, for example, a small alkyl group or —OH. Application of the compounds to corrosion protection is not mentioned.

JP-A 60-226 117 discloses monoesters of aliphatic dicarboxylic acids with polyglycols and their use for preparing electrolyte solutions for capacitors.

It is an object of the present invention to provide improved compounds for treating metal surfaces, especially for corrosion protection, which in addition to a very good corrosion protection effect have improved overcoatability particularly with aqueous basecoat materials. The compounds ought also to be suitable particularly for use in composite systems and ought to promote good adhesion between different layers. They ought also to be adaptable as simply as possible to different end applications.

We have found that this object is achieved by compounds of the formula X-Y-L-(W-Z)ₙ, where n is 1, 2 or 3 and X, Y, L, W, and Z have the following definitions:
X: an endgroup which is able to develop strong chemical and/or physical interactions toward metal surfaces, comprising at least one acidic group X¹, or salts thereof, or at least one hydrolyzable, Si-containing group X²,
Y: a hydrocarbon group having 5 to 60 carbon atoms, comprising units which are linked linearly with one another and are of substantially identical kind,
L: a linking group, which if n=1 is L¹, if n=2 is L², and if n=3 is L³, with L¹, L², and L³ having the following definitions:
   L¹: a linearly linking group which joins a hydrophobic group Y to a hydrophilic group W and is selected from the group consisting of S, —S—S—, —CO—O—, —O—CO—NR¹—, —NR¹CO—, —CO—NR¹—, —NR¹—CO, —NR¹—CO—NR¹—, and —NR¹—,
   L²: a branching group which joins a hydrophobic group Y to two hydrophilic groups W and is selected from the group consisting of —N<, —NR¹—CR^{1′}<, —CO—N<, —NR¹—CON<, and —CO—NR¹—CR^{1′}<,
   L³: a branching group which joins a hydrophobic group Y to three hydrophilic groups W and is selected from the group consisting of —NR¹C≡, NR¹—CH₂—C≡, —O—C≡, —O—CH₂≡, —CO—NR¹—CH₂—C≡, —CO—NR¹—CO—NR¹—CH₂—C≡, —CO—O—C≡, and
   R¹ and R^{1′}, each independently being H or C, to C₄ alkyl
W: a hydrophilic group, and
Z: an endgroup, being either a reactive endgroup Z¹ or a nonreactive endgroup z,
and,
where L¹ is —COO, the first endgroup X is not —COOH.

We have also found formulations for treating metal surfaces, said formulations comprising at least one such compound, and the use of such compounds to treat metallic surfaces, particularly for preventing corrosion.

The invention is detailed below.

In the compounds of the general formula X-Y-L-(W-Z)ₙ of the invention the linking group L joins a hydrophobic group Y to n hydrophilic groups W, n being 1, 2 or 3, Y is joined to the endgroup X, and W to the endgroup Z.

The group X is an endgroup which is able to develop strong chemical and/or physical interactions toward metal surfaces. The group comprises at least one acidic group X¹, or salts thereof, or at least one hydrolyzable, Si-containing group X².

The acidic group X¹ is preferably a group selected from the group consisting of —COOH, —SO₃H, —OSO₃H, —PO(OH)₂, —PO(OH)(OR²), —OPO(OH)₂, —OPO(OH)(OR²), and —CR³(NH₂)(COOH). With particular preference the acidic group X¹ is —COOH, —PO(OH)₂ or —OPO(OH)₂. Very particular preference is given to PO(OH)₂ or —OPO(OH)₂.

The radical R² is any desired group suitable as an ester group in phosphoric or phosphonic esters. It is preferably an unbranched or branched C₁ to C₈ alkyl group, which may also contain further substituents, especially OH groups. Examples of suitable radicals R² include ethyl, butyl, hexyl, octyl, 2-ethylhexyl, and 2-hydroxyethyl groups.
R³ is preferably H or C₁ to C₆ alkyl, more preferably H or a methyl group. It may also comprise radicals typical of naturally occurring α-amino acids. Examples include the radicals characteristic of lysine (—(CH₂)₄—NH₂), serine (—CH₂—OH), cysteine (—CH₂—SH), and tyrosine (—CH₂—C₆H₄—OH).

The acidic group X¹ can be in the form of an acid group. Alternatively it may have been partly or fully neutralized and, accordingly, be in the form of a salt. Particularly suitable counterions include alkali metal ions, alkaline earth metal ions, ammonium ions, and tetraalkylammonium ions, without any intention that the invention should be restricted to the ions.

The Si-containing groups X² have hydrolyzable bonds which are able to react with OH groups on the surface of the metals. In this case the groups X² may first undergo complete or partial hydrolysis with water to form —Si(OH)₃ groups, which then react with the surface. The reaction with the surface can of course also proceed without such an intermediate stage or by way of other intermediate stages. In particular the silicon-containing group X² is an —SiR⁴₃ group containing water-cleavable Si—R⁴ bonds. R⁴ can in particular comprise halogen radicals or alkoxy radicals. R⁴ is preferably Cl or an —OR⁵ radical, in which case R⁵ is preferably an unbranched or branched C₁ to C₆ alkyl radical.

The endgroup X preferably comprises just one group X¹ or one group X² attached in each case directly to the aliphatic hydrocarbon group Y. However, it may also be a larger endgroup comprising one or more groups X¹ or X² respectively. If two or more groups X¹ or X² are present, the endgroup X preferably comprises only X¹ or only X² groups. For specialty applications, however, the presence of both X¹ and X² in one endgroup is not ruled out. An endgroup preferably contains from 1 to 3 groups X¹ or X², respectively.

Examples of suitable endgroups X containing two or more groups X¹ or X², respectively, include in particular groups derived from polybasic carboxylic acids or polyhydric alcohols. The radicals in question may, for example, be radicals derived from malonic; citric, malic, maleic or fumaric acid. Examples of polyhydric alcohols include glycol, glycerol, and pentaerythritol. The alcohols may also be phosphated and so give groups X containing two or more phosphoric or phosphonic acid radicals.

The endgroup X is joined to the hydrophobic group Y. Y is a hydrocarbon group having 5 to 60 carbon atoms, comprising units which are linked linearly with one another and are of substantially identical kind. The group Y is preferably aliphatic and saturated, though may also comprise aromatic units. “Of substantially identical kind” is intended to denote that the group is constructed generally using units at least 90% of which are of identical kind. Preferably the group is formed exclusively of units of identical kind. The units may be unbranched or may contain branches. If branches are present they are preferably CH₃ groups. The linearly linked units constituting the group Y are preferably methylene units —CH₂—, propylene units —CH₂—CH(CH₃)— or isobutylene units —CH₂—C(CH₃)₂—.

More preferably Y is a linear alkyl chain having 8 to 20 carbon atoms, very preferably 9 to 15 carbon atoms.

If Y is a polyisobutylene group it has an average molar mass Mₙ of preferably from 150 to 750 g/mol, more preferably from 400 to 600 g/mol. Polyisobutylene units may in particular also include an aromatic unit.

The linking group L joins the hydrophobic group Y to the hydrophilic group or groups W, where if n is 1 the linking group is L¹, with n=2 it is L², and with n=3 it is L³.

L¹ is a linearly linking group selected from the group consisting of S, —S—S—, —CO—O—, —O—CO—, —CO—NR¹—, —NR¹—CO—, —O—CO—NR¹—, —NR¹—CO—O—, —NR¹—CO—NR¹—, and —NR¹—. The linking group is preferably —CO, —C—, —CO—NR¹—, —NR¹—CO—, O—CO—NR¹—, —NR¹—CO—O— or —NR¹—CO—NR^{1′}—, and very preferably —CO—NR¹—. Where L¹ is —CO—O— the endgroup X is not —COOH.

R¹ and R^{1′} independently are each H or a straight-chain or branched alkyl group which optionally may also comprise further substituents. R¹ is preferably H or C₁ to C₄ alkyl and very preferably H or methyl.

The group L² contains a branch. It links a hydrophobic group Y to two hydrophilic groups W. In the case of actual branching the branching site in question is preferably a nitrogen atom which bonds two hydrophilic groups W, while the third bond is joined directly or indirectly to Y. The branching group L² is preferably a group selected from the group consisting of —N<, —NR¹—CR^{1′}<, —CO—N<, —NR¹—CO—N<, and —CO—NR¹—CR^{1′}<, where R¹ and R^{1′} are as defined above. With particular preference L² is —CO—N< or CO—NR¹—CR^{1′}<.

The group L³ is likewise branching. It links a hydrophobic group Y to three hydrophilic groups W. In the case of actual branching the branching site in question is preferably a carbon atom which bonds three hydrophilic groups W, while the fourth bond is joined directly or indirectly to a heteroatom, in particular O or N, which is in turn joined to Y. The branching group L³ is preferably a group selected from the group consisting of —NR¹—C≡, —NR¹—CH₂—C≡, —O—C≡, —O—CH₂—C≡, —CO—NR¹—CH₂—C≡, —CO—NR¹—C≡, —CO—NR¹—CH₂—C≡; —CO—O—C≡, and —CO—O—CH₂—C≡.

With particular preference L³ is —CO—NR¹—C≡, —CO—NR¹—CH₂—C≡, —CO—O—CH₂—C≡, and very preferably —CO—NR¹—C≡(NB: The symbol “≡” here stands for 3 single bonds).

The hydrophilic group W is selected by the skilled worker in accordance with the degree of desired hydrophilicity. Suitable groups W are in particular those groups which besides carbon atoms comprise oxygen and/or nitrogen atoms, in the form for example of alcohol, ether or amino groups. W is preferably a group comprising C₂ to C₄ alkoxylate units. Through the number and nature of the selected alkoxylate units it is possible for the skilled worker to define the group W properties that are desired in each case in accordance with the envisaged utility.

The compounds of the invention preferably contain from 1 to 10 alkoxylate units, preferably from 1 to 5 alkoxylate units. The skilled worker is aware that such alkoxy groups can be obtained, for example, by alkoxylation or starting from industrial polyglycols. The values stated therefore represent the average number of units, the average value being, of course, not necessarily a natural number but also any desired rational number.

The hydrophilic groups W are preferably groups comprising predominantly ethoxylate units. The skilled worker is aware that the properties of such groups can be fine-tuned by using small amounts of propoxylate or butoxylate units.

The endgroup Z joined to W can be a reactive endgroup Z¹ or a nonreactive endgroup Z². For the purposes of this invention “reactive” means that the group Z¹ is able to form bonds with reactants typically used in paints or coatings. The reactive group Z¹ is in particular a group selected from the group consisting of —OH, —SH, —NH₂, —NHR⁶, —CN, —NCO, epoxy, —CH═CH₂, —CO—CR⁷═CH₂, —NR⁶—CR⁷═CH₂, and —COOH. One group Z¹ may optionally also comprise two or more of these groups. R⁶ is normally H or a straight-chain or branched C₁ to C₆ alkyl group and R⁷ is H or CH₃. Z¹ is preferably OH, —SH, —NH₂, —NHR⁶ or —COOH and very preferably —OH or —CH═CH₂.

Nonreactive groups Z² are in particular groups which do not contain acidic hydrogen atoms or ethylenically unsaturated groups or groups capable of undergoing addition reactions. Particular nonreactive groups are hydrogen atoms, alkyl groups or groups in which acidic hydrogen atoms have been substituted by alkyl groups, such as, for example, ether groups, carboxylic ester groups, tertiary amino groups or alkylated carboxamides. The nonreactive group Z² is preferably a group selected from the group consisting of —H, —OR⁸, —NR⁸R⁹, —COOR⁸, and —CONR⁸R⁹. R⁸ and R⁹ independently are each straight-chain or branched C₁ to C₆ alkyl radicals, preferably methyl or ethyl groups.

Compounds particularly suitable for treating metal surfaces contain phosphate or phosphonate endgroups X¹, a linear C₈ to C₂₀ alkyl group Y, a carboxamido group —CO—NH— or carboxylic ester group —CO—O— as linking group L¹, a hydrophilic group W comprising 1 to 5 ethoxy groups, and H or OCH₃ as endgroup Z².

There are a number of synthesis routes available for the compounds of the invention, depending on the nature of the desired endgroups and of the linking group.

Suitable starting materials for the compounds of the invention are α,ω-difunctional compounds of the general formula α-Y-ω. The two functional groups are connected by the hydrocarbon group Y, which is as defined above. The two functional groups can be the same or different. One of the two functional groups forms the endgroup X or can be used to form the endgroup. The other functional group forms the linking group L or can be used to form the linking group. Examples of possible difunctional compounds include ω-carboxyalkyl-1-enes, ω-hydroxyalkyl-1-enes, and ω-hydroxycarboxylic acids and/or their cyclic esters. Examples of suitable starting compounds include ω-dec-1-enoic acid, ω-undec-1-enoic acid, 9-hydroxynonanoic acid, and ε-caprolactone.

ω-Hydroxycarboxylic acids (1) or their cyclic esters (1′) can be reacted, for example, with methylpolyethylene glycol amines (2) in accordance with the following scheme:

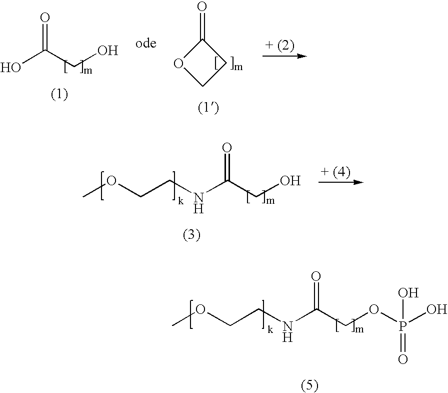

Reaction of the hydroxycarboxylic acid (1) with methylpolyethylene glycol amines (2) produces a carboxamide (3). The hydroxyl group of the carboxamide can be reacted for example with polyphosphoric acid (4). This produces the inventive compound (5), containing a phosphoric acid group X¹ and a carboxamido linking group L¹. The OH group can also be utilized to attach other acidic groups X¹ or Si-containing groups X².

By reacting ω-phosphatoalkylamines with ethylene carbonate it is possible to obtain compounds containing a phosphoric acid group X¹ and a urethane linking group L¹, as shown in the following scheme:

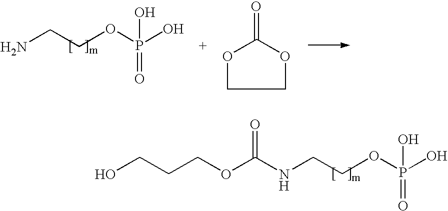

Compounds with branching groups L² or L³ can be obtained by replacing methylpolyethylene glycol amines (2) in the above synthesis scheme with other compounds (2′) containing branches. Examples include amines of the general formula HN[(CH₂—CH₂—O—)ₖR⁸]₂ or H₂N—C—[CH₂O—(CH₂—CH₂—O—)ₖR⁸]₃, in which R⁸ is as defined at the outset. The arms of said compounds can be the same or different.

Replacing the polyethylene glycol amines (2) with alcohols (2″) gives compounds containing an ester group as linking group. Suitable alcohols are in particular, oligoethylene or polyethylene glycol or derivatives thereof, such as monoethers, or compounds containing more than one oligoethylene or polyethylene glycol group or derivatives. Examples that may be mentioned include compounds of the general formula HO—CH—[CH₂O—(CH₂—CH₂—O—)ₖR⁸]₂ or HO—C—[CH₂O—(CH₂—CH₂—O—)ₖR⁸]₃.

To synthesize compounds containing phosphonic acid endgroups it is possible to use preferably difunctional compounds α-Y-ω containing an olefinic group. Examples include ω-carboxyalkyl-1-enes or ω-hydroxyalkyl-1-enes. A free-radical mechanism can be used to attach dialkyl phosphites to such olefinic groups, as described for example in Nifant'ev et al. in Russian Journal of General Chemistry, 63, 8, Part 1, 1993, 1201-1205. The phosphonic ester group can be subsequently hydrolyzed with suitable acids. This is illustrated by way of example in the following synthesis scheme: 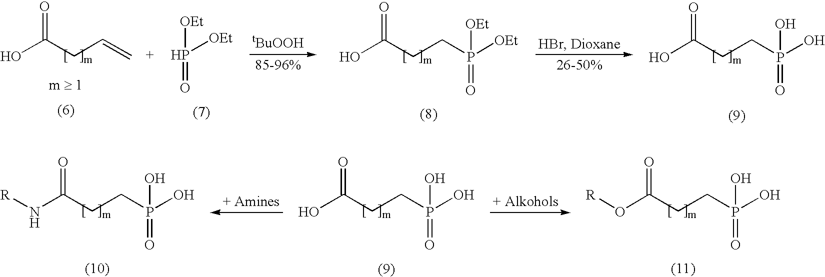
A ω-carboxyalkyl-1-ene (6) is first reacted with a dialkylphosphonic ester (7) to give the ω-carboxyalkyl-1-phosphonic ester (8), which is hydrolyzed to the ω-carboxyalkyl-1-phosphonic acid (9). The hydrophilic group W and the endgroup Z can then be hung onto the carboxylic acid function, by reaction for example with ethylene glycol, diethylene glycol, oligo/polyethylene glycols, alkylpolyethylene glycols, polyethylene glycol amines or alkylpolyethylene glycol amines, and also the abovementioned branching alcohols and amines. Depending on the nature of the compound used the resultant compounds have as their linking group a carboxamido group (10) or a carboxylic ester group (11).

Further synthesis variants for inventive compounds are assembled schematically below:

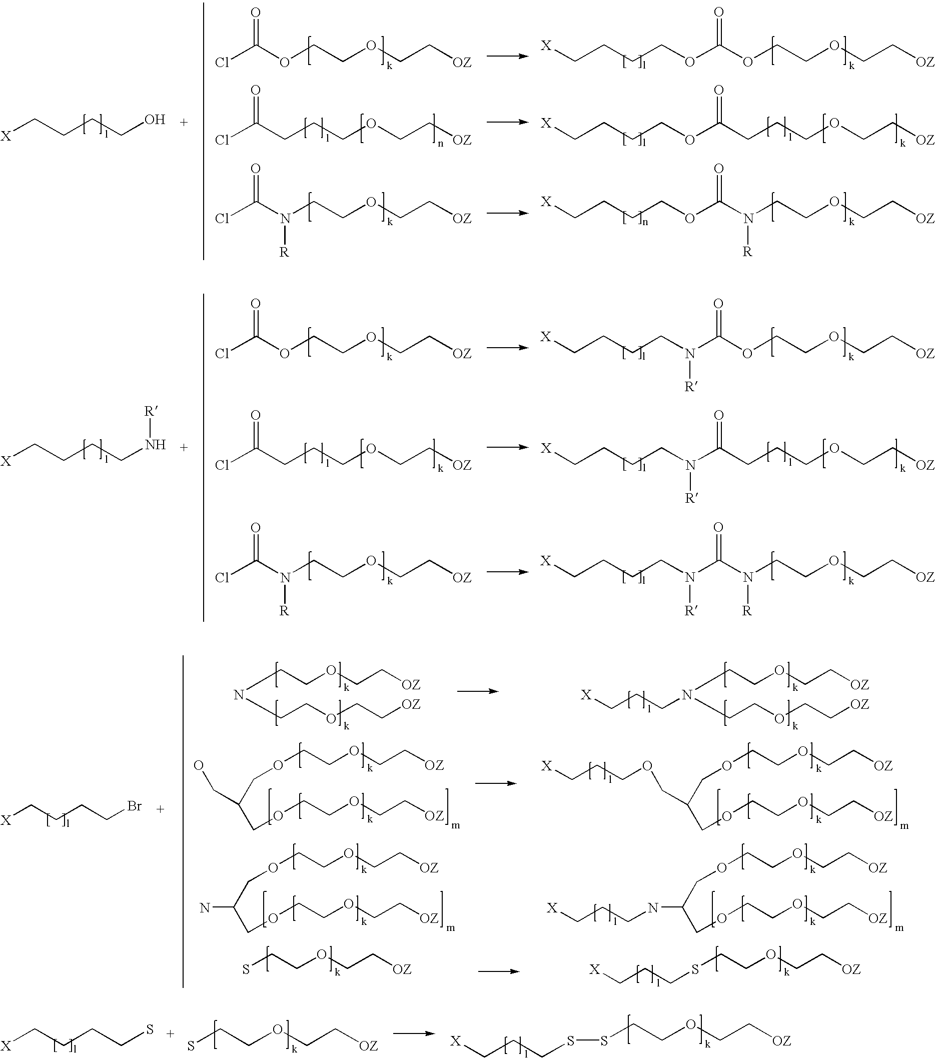

The compounds of the invention are particularly suitable for use as corrosion inhibitors. For this purpose they can be added to products, such as liquid mixtures, for example, which in contact with metals would cause or accelerate corrosion. Examples include paints, varnishes or cleaning products. Alternatively they may be used in special corrosion protection formulations.

They are additionally suitable for coating, or as an aid to coating substrates of all kinds, such as metals, plastics, ceramics, glass or composites thereof.

They can also be used as adhesion promoters. In this respect they are particularly suitable for joining different kinds of materials to form composites. For this purpose the two endgroups, X and Z, can be adapted for good adhesion to in each case one of the materials, in order to give a firm bond. Composites may be obtained, for example, from metal foils and polymeric films. Such composites are used in particular to produce packaging materials.

The compounds of the invention may also be used with very particular advantage to produce monomolecular layers on metallic surfaces. For this purpose it is preferred to use compounds having a linearly linking group L¹.

The compounds of the invention can be used in particular to treat metals or metal surfaces. By treatment is meant not only those operations after which the compounds of the invention remain temporarily or permanently on the surface but also those in which no compounds remain on the surface. Examples include their use as adhesion promoters, corrosion inhibitors, primers, passivating agents or conversion coat formers.

The compounds of the invention can be used as they are to treat metals as such. They can be sprayed or poured onto a metallic surface, for example.

Preferably, however, metal surfaces are treated using formulations which comprise at least one of the compounds of the invention. As a general rule the formulations of the invention include one or more of the compounds of the invention, a suitable solvent, and, optionally, further components.

Suitable solvents are those solvents or solvent mixtures which are capable of dissolving, dispersing, suspending or emulsifying the compounds of the invention. These may be organic solvents or water. Naturally, mixtures of different organic solvents or mixtures of organic solvents with water can also be used. From the solvents which are possible in principle, the skilled worker makes an appropriate selection in accordance with the desired end use and with the nature of the particular inventive compound used. The skilled worker will appreciate that in the case of compounds containing an endgroup X² he or she must only use solvent mixtures which do not cause premature hydrolysis of the endgroup.

Examples of organic solvents include hydrocarbons such as toluene, xylene or mixtures as obtained, for example, during the refining of crude oil, which are available commercially, for example, as petroleum spirit, kerosene, Solvesso® or Risella®, ethers such as THF or polyethers such as polyethylene glycol, ether alcohols such as butylglycol, hexylglycol, ether glycol acetates such as butylglycol acetate, ketones such as acetone, and alcohols such as methanol, ethanol or propanol. Ethoxylated monohydric or polyhydric alcohols can also be used, especially products derived from C₄ to C₈ alcohols.

Preferred formulations are those comprising water or a predominantly aqueous solvent mixture. This includes mixtures containing at least 50% by weight, preferably at least 65% by weight, and very preferably at least 80% by weight water. Further components are water-miscible solvents. Examples include monoalcohols such as methanol, ethanol or propanol, higher alcohols such as ethylene glycol or polyetherpolyols, and ether alcohols such as butylglycol or methoxypropanol, or ethoxylated C₄-C₈ alcohols.

Particularly preferred formulations are those whose solvent comprises water. The pH of an aqueous solution is determined by the skilled worker in accordance with the nature of the desired application. Buffer systems too, of course, can be used to set the pH at a particular level.

The amount of compounds of the invention dissolved, dispersed, suspended or emulsified in the solvent is determined by the skilled worker in accordance with the nature of the derivative and with the desired application. As a general rule, though, the amount is from 0.1 to 100 g/l, preferably from 0.5 to 50 g/l, and very preferably from 1 to 20 g/l, without wishing to restrict the invention. These figures relate to a ready-to-use formulation. Naturally, concentrates can also be formulated, for dilution to the desired concentration in situ prior to actual use.

The formulations of the invention, furthermore, may also include additional components.

The nature and amount of the compounds X-Y-L-(W-Z)ₙ of the invention in the formulation are selected by the skilled worker in accordance with the desired application. Only a single such compound can be selected, or else two or more different compounds.

The properties desired for the particular application can be determined in particular through the nature of the endgroups X and Z, the nature and length of the hydrocarbon group Y, and the nature and length of the hydrophilic group W. A near-infinite range of desired properties can be formulated in this way. Also, of course, the properties can be steered by using a mixture of two or more compounds of the invention plus additional components.

Additional components can be suitable polymeric binders. The nature and amount of the binder depend on the desired application.

Formulations which include polymers are particularly suitable for overcoating.

It is also possible to use dispersing auxiliaries, emulsifiers or surface-active compounds. Examples include cationic, anionic, zwitterionic, and nonionic surfactants, such as alkyl alkoxylates with ethylene oxide and/or propylene oxide units. The formulations may also include further corrosion inhibitors, such as butynediol, benzotriazole, aldehydes, amine carboxylates or suitable phosphoric esters, for example.

Fine metal particles, too, can be used in the formulations. Preferred metal particles include, in particular, lamellae made of Al and/or Zn. Formulations which include such lamellae can also be used as corrosion-preventative coatings.

The fine-tuning of performance properties is illustrated by way of example with reference to the following embodiments of the invention, which are not intended to restrict the invention.

A compound containing just a single ethoxy group as hydrophilic group W and a —OCH₃ group as endgroup Z² can be used, for example, to hydrophobicize an aluminum surface. If the hydrophilic group W is extended with further ethoxy groups, there is an increase in the hydrophilic nature of the surface. A compound which differs from that stated above only in that it has three ethoxy groups instead of one can be used to hydrophilicize aluminum surfaces.

Formulations comprising at least one compound having a reactive endgroup Z¹ in a mixture with at least one compound having a nonreactive endgroup Z² can be used with particular advantage. Depending on the Z¹/Z² ratio it is possible, for example, to tailor the firmness of adhesion of composites.

It is also possible with advantage to use formulations which comprise not only compounds of the invention but also the compounds XYZ described in WO 98/29580, in which two endgroups X and Z are separated from one another by a single hydrophobic group Y, as additional components. The properties of the coating can be varied in a particularly elegant fashion by mixing with the compounds of the invention. For example, the compounds of the invention can provide for a desired hydrophilicization of the surface while the compounds XYZ provide for the attachment of a second paint coat.

In accordance with the invention the compounds and/or formulations of the compounds can be used for the surface treatment of metals of all kinds. The surfaces in question may of course also be those of alloys of different metals. They may be largely planar surfaces, in other words for example the surface of metal sheets, foils, coils, and the like. Alternatively the surface can be of bodies of arbitrary shape. This includes inter alia the surfaces of very fine particles, of metal powders, metal flakes or metal pigments, for example. The surface of materials coated with metallic layers is included as well.

The compounds and/or formulations of the invention can of course also be used to treat the insides of hollowed bodies. Examples include their use as radiator protectants, in heat exchanger circuits or in heating systems.

The metal or metals to be treated are preferably one or more selected from the group consisting of zinc, aluminum, magnesium, chromium, iron, nickel, and tin, and also alloys of these metals with one another or with other metals. The compounds/formulations of the invention are particularly suitable for treating tin and/or aluminum and also for treating steels, including stainless steels.

In the context of the inventive use for metal surface treatment a metal surface is contacted with the formulation of the invention by spraying, dipping, painting or roller coating, for example. After a dipping operation, excess treatment solution can be removed by allowing the workpiece to drip dry; in the case of metal sheets, metal foils or the like, however, it is also possible for excess treatment solution to be removed, for example, by squeezing.

Where a temporary or permanent coating is required, the solvent is removed subsequently, by raising the temperature, for example.

The operations in, question may be those referred to as “no-rinse” operations, in which the treatment solution, immediately following its application, without being rinsed off, is dried directly in a drying oven. The treatment may also of course comprise rinsing steps prior to removal of the solvent, rinsing steps thereafter, and additional aftertreatment steps.

The compounds of the invention are also especially suitable for producing composites comprising at least one metallic layer, a layer (A), which comprises at least one of the compounds of the invention, and at least one second layer (B). It is preferred to use compounds which have a reactive group Z¹, so that further layers can also be coupled on reactively. Layer (A) is disposed between the metal layer and layer (B). In one particular embodiment, layer (A) is a monomolecular layer. The second layer (B) can be, for example, a paint coat. The composite may of course also comprise further layers. For example, the metal layer may also have been provided with a pretreatment layer. The metallic layer can of course also be coated on both sides with a layer (A). The composites of the invention exhibit excellent adhesion between the metal layer and layer (B).

The following examples are intended to illustrate the invention:

Preparing the starting materials:

### 9-Hydroxynonanoic acid

9-Hydroxynonanoic acid was obtained as described by W. Youchu, L. Fuchu, Synthetic Communications 1994, 24(9), 1265-1269 by ozonizing unsaturated fatty acids and working up the reaction mixture. Since the composition of a natural product such as oleic acid is not uniform, the products obtained are frequently mixtures (depending on the starting material employed).

Methyldiglycolamine

200 g of diethylene glycol monomethyl ether (Fluka) were charged with 700 ml of THF and 100 g of catalyst H1/88 (BASF) to a 2.5 l stirred autoclave. This initial charge is then rendered inert twice with 5 bar of nitrogen, after which 500 ml of ammonia are added at room temperature. Hydrogen is then added at room temperature to a pressure of 50 bar and the mixture is heated to 200° C. with stirring. When 200° C. has been reached the pressure is raised to 270 bar by adding hydrogen.

The mixture was subsequently stirred at 200° C. for 12 hours and then cooled to 30° C. After further heating to 40° C. it was stirred with the autoclave open for a further hour, then flushed twice with 10 bar of nitrogen, and again cooled to room temperature.

The reaction discharge is filtered-through a fluted filter, then admixed with a tablespoon of silica gel and a little Hyflow. It is shaken once and, after 5 minutes, filtered again. The clear colorless solution is concentrated under reduced pressure to 50° C. on a rotary evaporator. The product can be used without further purification in the following steps.

Methyltriglycolamine

The procedure described above was repeated but using 200 g of triethylene glycol monomethyl ether (Fluka) instead of diethylene glycol monomethyl ether.

### Synthesis of the compounds of the invention

I Linking the Hydrophobic and Hydrophilic Moieties

### EXAMPLE 1

### Amidating 9-hydroxynonanoic acid with methylmonoglycolamine

24.1 g (0.1 mol) of 9-hydroxynonanoic acid (OH number: 79, acid number 233 mg KOH/g, employed in accordance with acid number) and 0.5 g of orthophosphoric acid (85%) were mixed and the mixture was heated to 100° C. under a nitrogen atmosphere. 7.5 g (0.1 mol) of methylmonoglycolamine (Merck) were added dropwise over the course of 15 minutes and the mixture was subsequently heated to 150° C. Water of reaction formed was separated off over a distillation bridge, with nitrogen being passed through. After a reaction time of 36 hours the reaction mixture was cooled to room temperature and the reaction discharge was used without further workup in the next step.

### EXAMPLE 2

### Amidating 9-Hydroxynonanoic acid with methyldiglycolamine

The procedure of example 1 was repeated but using 13.6 g (0.1 mol) of methyldiglycolamine as starting material instead of methylmonoglycolamine.

### EXAMPLE 3

### Amidating 9-Hydroxynonanoic acid with methyltriglycolamine

The procedure of example 1 was repeated but using 16.2 g (0.1 mol) of methyltriglycolamine as starting material instead of methylmonoglycolamine.

### EXAMPLE 4

### Amidating, ε-caprolactone with methylmonoglycolamine

22.8 g (0.2 mol) of ε-caprolactone (Fluka) and 0.5 g of orthophosphoric acid (85%) were mixed and the mixture was heated to 100° C. with stirring (nitrogen atmosphere). 15.0 g (0.2 mol) of methylmonoglycolamine (Merck) were added over the course of 15 minutes. Reaction was carried out at 105° C. for 48 hours, after which the reaction mixture was cooled to room temperature and the reaction discharge was used without further workup in the next step.

### EXAMPLE 5

### Amidating ε-caprolactone with methyldiglycolamine

The procedure of example 4 was repeated but using 272 g (0.2 mol) of methyldiglycolamine as starting material instead of methylmonoglycolamine.

### EXAMPLE 6

### Amidating ε-caprolactone with methyltriglycolamine

The procedure of example 4 was repeated but using 32.5 g (0.2 mol) of methyltriglycolamine as starting material instead of methylmonoglycolamine.

II Attaching the Acidic Endgroups X

### EXAMPLE 7

### Phosphating the amide of 9-hydroxynonanoic acid and methylmonoglycolamine

The product of example 1 (20 g, 0.0671 mol) and 0.1 g of hypophosphorous acid (50%) were charged to the reaction flask under a nitrogen atmosphere. 9.7 g (0.0839 mol) of polyphosphoric acid (85%) were added over the course of 15 minutes. During the addition the temperature of the reaction mixture rose to 50° C. After the end of the addition it was heated further to 75° C. and stirred at this temperature for 20 hours. The reaction was monitored by ³¹P-NMR analysis.

### EXAMPLE 8

### Phosphating the amide of 9-hydroxynonanoic acid and methyldiglycolamine

The procedure of example 7 was repeated but using the product from example 2 (30 g, 0.0836 mol) and 12.0 g (0.1045 mol) of polyphosphoric acid (85%).

### EXAMPLE 9

### Phosphating the amide of 9-hydroxynonanoic acid and methyltriglycolamine

The procedure of example 7 was repeated but using the product from example 3 (30 g, 0.078 mol) and 11.2 g (0.1045 mol) of polyphosphoric acid (85%).

### EXAMPLE 10

### Phosphating the amide of ε-caprolactone and methylmonoglycolamine

The procedure of example 7 was repeated but using the product from example 4 (30 g, 0.1586 mol) and 22.9 g (0.1983 mol) of polyphosphoric acid (85%).

### EXAMPLE 11

### Phosphating the amide of ε-caprolactone and methyldiglycolamine

The procedure of example 7 was repeated but using the product from example 5 (30 g, 0.1085 mol) and 15.6 g (0.1983 mol) of polyphosphoric acid (85%).

### EXAMPLE 12

### Phosphating the amide of ε-caprolactone and methyltriglycolamine

The procedure of example 7 was repeated but using the product from example 6 (30 g, 0.12 mol) and 17.3 g (0.15 mol) of polyphosphoric acid (85%).

### Application Examples

### EXAMPLE 13

### Hydrophobicizing aluminum

A small punched aluminum plate without further surface treatment is immersed in an aqueous solution comprising 0.1% of a 9-methylmonoglycolamidononyl phosphate and 5% of cumene-sulfonate. After 20 hours the plate is removed and the water contact angle is determined in accordance with methods known from the literature. The contact angle found is 75°. An untreated metal surface has a contact angle of around 60°.

### EXAMPLE 14

### Hydrophilicizing aluminum

A small punched aluminum plate without further surface treatment is immersed in an aqueous solution comprising 0.1% of a 9-methyltriglycolamidononyl phosphate and 5% of Emulan® HE50 (solubilizer, BASF AG, Ludwigshafen). After 20 hours the plate is removed and the water contact angle is determined in accordance with methods known from the literature. The contact angle found is 10°. An untreated metal surface has a contact angle of around 60°.

### EXAMPLE 15

### Use for corrosion protection

A galvanized steel sheet was treated by the method of example 13 with 6-methyldiglycolamido-hexyl phosphate (without cumenesulfonate) (contact angle <200) and was characterized electrochemically. Static and cyclic electrovoltammetry were conducted. A selection of the characteristics measured is shown in table 1.

TABLE 1

| Parameter | Untreated sheet | Treated sheet |
|---|---|---|
| Static resting potential/mV | −600 | approx. −640 |
| Polarization resistance/kΩ | approx. 6 | approx. 30 |
| Cyclic resting potential/mV | −600 | approx. −700 |
| Corrosion current/μA/cm² | approx 2 | approx 0.3 |

The steel plate was also tested for corrosion resistance by means of a salt spray test in accordance with DIN 10289.

The test was carried out on three specimens and two untreated metal sheets for comparison. The corrosion resistance was evaluated on a scale from 10 (no corrosion) to 1 (severe corrosion). Evaluations were made in each case after a test period of not less than 1 hour up to 6 hours, and are compiled in table 2.

TABLE 2
Results of the salt spray tests

| Test | | | | Compar- | Compar- |
|---|---|---|---|---|---|
| period | Sheet 1 | Sheet 2 | Sheet 3 | ative 1 | ative 2 |
| [h] | (treated) | (treated) | (treated) | (untreated) | (untreated) |
| 1 | 10 | 10 | 10 | 1 | 1 |
| 2 | 9 | 9 | 10 | 0 | 0 |
| 3 | 9 | 9 | 10 | 0 | 0 |
| 4 | 5 | 5 | 10 | 0 | 0 |
| 5 | 4 | 4 | 10 | 0 | 0 |
| 6 | 2 | 2 | 10 | 0 | 0 |

1-29. (canceled)

30. A compound of formula X-Y-L-W-Z, wherein:
X is an endgroup which is able to develop strong chemical and/or physical interactions toward metal surfaces, comprising
(a) at least one acidic group X¹ selected from the group consisting of —COOH, —SO₃H, —OSO₃H, —PO(OH)₂, —PO(OH)(OR²), —OPO(OH)₂, —OPO(OH)(OR²) and —CR³(NH₂)(COOH) or salts thereof, R² being an unbranched or branched C₁ to C₈ alkyl group with or without further substituents, and R³ being H, a C, to C₆ alkyl group or the residues of naturally occurring amino acids, or
(b) at least one hydrolyzable, Si-containing group X²,
Y is a hydrocarbon group having 5 to 60 carbon atoms, comprising units which are linked linearly with one another and are of substantially identical kind,
L is a linearly linking group —CO—NR¹-(L¹), R¹ being H or C₁ to C₄ alkyl,
L¹ is a linearly linking group which joins a hydrophobic group Y to a hydrophilic group W and is selected from the group consisting of S, —S—S—, —CO—O—, —O—CO—, —CO—NR¹—, —NR¹—CO—, —O—CO—NR¹—, —NR¹—CO—O—, —NR¹—CO—NR¹—, and —NR¹—,
R¹ is H or a straight-chain or branched alkyl which optionally is further substituted,
W is a hydrophilic group, and
Z is an endgroup, being either
(a) a reactive endgroup Z¹, wherein Z¹ is selected from the group consisting of —OH, —SH—, —NH₂, —NHR⁶, —CN, —NCO, epoxy, —CH═CH₂, —O—CO—CR⁷═CH₂, —NR⁶—CO—CR⁷═CH₂, and —COOH, R⁶ being H or C₁ to C₆ alkyl and R⁷ being H or CH₃ or
(b) a nonreactive endgroup Z², wherein Z² is selected from the group consisting of —H, —OR⁸, —NR⁸R⁹, —COOR⁸, and —CONR⁸R⁹, wherein R⁸ and R⁹ independently being C₁ to C₆ alkyl.

31. A compound according to claim 30, wherein the acidic group X¹ is at least one group selected from the group consisting of —COOH, —PO(OH)₂, and —OPO(OH)₂ or salts thereof.

32. A compound according to claim 30, wherein the hydrolyzable, silicon-containing group X² is a group —SiR⁴₃, R⁴ is Cl or a radical —OR⁵ where R⁵ is C₁ to C₆ alkyl.

33. A compound according to claim 30, wherein Z¹ is a group selected from the group consisting of —OH, —SH, —NH₂, —NHR⁶, and —COOH.

34. A compound according to claim 30, wherein the linearly linked units of the hydrocarbon group Y are units selected from the group consisting of —CH₂— and —CH₂—CH(CH₃)— and —CH₂—.

35. A compound according to claim 34, wherein Y is a linear alkyl chain having 8 to 20 carbon atoms.

36. A compound according to claim 35, wherein Y is a linear alkyl chain having 9 to 15 carbon atoms.

37. A compound according to claim 30, wherein the hydrophilic group W is a group comprising C₂ to C₄ alkoxylate units.

38. A compound according to claim 37, wherein the hydrophilic group W comprises 1 to 10 alkoxylate units.

39. A compound according to claim 38, wherein the units number 1 to 5.

40. A compound according to claim 38, wherein the alkoxylate units are ethoxylate units.

41. A compound according to claim 30, which further comprises a corrosion inhibitor.

42. An adhesion promoter, primer, passivator or conversion coat former which comprises the compound according to claim 30.

43. A process to produce monomolecular layers on metallic surfaces which comprises using the compound as claimed in claim 30.

44. A formulation for treating metal surfaces, comprising at least one compound according to claim 30, a solvent or solvent mixture, and, optionally, further components.

45. The formulation according to claim 44, comprising at least one compound having a reactive endgroup Z¹ and at least one compound having a nonreactive endgroup Z². wherein Z¹ is selected from the group consisting of —OH, —SH—, —NH₂, —NHR⁶, —CN, —NCO, epoxy, —CH═CH₂, —O—CO—CR⁷═CH₂, —NR⁶—CO—CR⁷═CH₂, and —COOH, R⁶ being H or C₁ to C₆ alkyl and R⁷ being H or CH₃ and
Z² is selected from the group consisting of —H, —OR⁸, —NR⁸R⁹, —COOR⁸, and —CONR⁸R⁹, wherein R⁸ and R⁹ independently being C₁ to C₆ alkyl.

46. The formulation according to claim 44, wherein the compound further comprises metal particles.

47. The formulation according to claim 48, wherein the metal particles are lamellae of Al or Zn or a mixture thereof.

48. A method of treating metal surfaces which comprises contacting the metal surface with a formulation according to claim 46.

49. The method according to claim 48, wherein the metal comprises one or more selected from the group consisting of zinc, aluminum, magnesium, chromium, iron, nickel, and tin or alloys of these metals with one another or with other metals.

50. A composite comprising at least one metallic layer, a layer (A) comprising at least one compound according to claim 30, and a second layer (B).

51. The composite according to claim 50, wherein the layer (A) is a monomolecular layer.

52. The composite according to claim 50, wherein the second layer (B) is a paint coat.

53. The composite according to claim 50, further comprising a pretreatment layer which has been applied to the metal.
